(19) United States
(12) Patent Application Publication
(10) Pub. No.: US 2011/0016628 A1
(43) Pub. Date: Jan. 27, 2011

(54) PORTABLE APPARATUS FOR MOVING SUBJECTS

(76) Inventor: Russell P. Masterson, JR., Lake Villa, IL (US)

Correspondence Address: Russ Weinzimmer, 614 Nashua Street, Suite 53, Milford, NH, 03055, US

(21) Appl. No.: 12/506,912

(22) Filed: Jul. 21, 2009

(51) Int. Cl. A61G 7/10

(52) U.S. Cl. 5/87.1; 5/86.1; 5/83.1; 5/89.1

(57) ABSTRACT

A portable apparatus for moving subjects is claimed in which a base structure has one or more rolling devices attached to facilitate moving of the apparatus. A stem structure rising from the base structure in turn supports a moveable support arm having a having pulley affixed to a distal end. A moveable lifting line capable of supporting a lifted subject ends in a fitting. A pulling mechanism is attached to the apparatus and operably coupled to the lifting line, whereby a subject secured to the fitting can be lifted and moved. In disclosed preferred embodiments, the portable apparatus for moving subjects is configured for lifting a subject without lifting movement of the support arm.

### FIELD OF THE INVENTION

The invention generally relates to an apparatus for moving items, and more specifically to a portable apparatus for moving human subjects such as physically impaired individuals.

### BACKGROUND OF THE INVENTION

It is known to lift, move, and lower objects with an extended moveable boom such as a construction crane. It is also known to lift and lower objects with a fixed boom such as that found on some marine davit apparatus. There is a need, however for more specialized lifting, moving, and lowering apparatus, particularly in the medical field. The movement of an impaired or invalid medical subject for ingress and egress to and from a common passenger vehicle, for example, presents particular problems. Crane and davit systems found in the art are not readily suited for such applications, due to space and access constraints presented by the size and orientation of vehicle entrances, for example. Cranes that perform lifting functions using a pivoting boom are typically limited by the requirement that a subject be inserted into a vehicle more-or-less horizontally, rather than in an arc from above. Davit apparatus, such as those applied in maritime applications, are generally suited for vertical raising and lowering, but not for strictly horizontal movement. In the cases of both davits and cranes known in the art, the bulk and lack of portability of the apparatus are generally limiting factors ruling out the ready movement of relatively small loads, such as less than 500 pounds, into and out of relatively small openings, such as the doors of common passenger vehicles.

Due to these and other problems and potential problems with the current state of the art, improved lifting and moving mechanisms for use in the context of moving human subjects would be useful and advantageous.

### SUMMARY OF THE INVENTION

In carrying out the principles of the present invention, in accordance with preferred embodiments, the invention provides advances in the arts with novel apparatus directed to providing mobility assistance useful for moving subjects into and out of seats, vehicles, or other conveyances. The apparatus provides portable lifting and moving systems that are readily adjustable for presenting their load to a relatively small target area. The apparatus also avoids some of the practical problems with the prior art by reducing or eliminating reliance on the use of a boom for applying lifting force to the load, allowing a substantially horizontal support arm to remain in the same position as the load, or passenger, is raised or lowered. The configuration of the apparatus is also adapted to place the moved subject's torso in proximity to the support arm, further contributing to the utility of the apparatus in relatively close quarters.

According to one aspect of the invention, a preferred embodiment includes a portable base structure fitted with one or more rolling devices such as wheels. A stem structure rises from the base structure. A moveable support arm is affixed to the stem structure, with a pulley affixed to a distal end of the support arm. A moveable lifting line operably engaged by the pulley and includes a fitting at its distal end. A pulling mechanism mounted to the apparatus is coupled to the lifting line such that a subject secured to the fitting to be lifted, and/or lowered, and moved.

According to another aspect of the invention, a preferred embodiment of portable moving apparatus is configured for lifting a subject without the exertion of lifting force by movement of the support arm.

According to another aspect of the invention, a preferred embodiment includes a pivotable joint coupling the proximal end of the support arm to the stem structure.

According to yet another aspect of the invention, a preferred embodiment includes a support arm elevator for pivoting and supporting the support arm at a selected angle relative to the stem, and for adjusting the height of the distal end of the support arm relative to the base.

According to another aspect of the invention, in a preferred embodiment of the portable moving apparatus for moving subjects, the support arm elevator is coupled between the support arm and the stem structure.

According to an additional another aspect of the invention, a preferred embodiment includes a support arm elevator is coupled between the support arm and the base.

According to still another aspect of the invention, a preferred embodiment includes a support arm elevator having a hydraulic mechanism operable for moving the support arm.

According to a further aspect of the invention, a preferred embodiment includes a support arm elevator having a pneumatic mechanism operable for moving the support arm.

According to yet another aspect of the invention, a preferred embodiment includes one or more telescopic sections for moving the distal end of the support arm relative to the proximal end attached to the stem.

According to an aspect of the invention, a preferred embodiment includes a support arm endowed with one or more moveable peg-and-hole adjustment positions for moving the distal end of the support arm relative to the proximal end attached to the stem.

According to an aspect of the invention, a preferred embodiment includes a harness for securing a subject to the lifting line for movement.

According to an aspect of the invention, in a preferred embodiment, the pulling mechanism of the portable moving apparatus is secured to the base.

According to another aspect of the invention, in a preferred embodiment, the pulling mechanism is secured to the stem of the portable moving apparatus.

According to still another aspect of the invention, a preferred embodiment includes a pulling mechanism secured to the support arm.

According to another aspect of the invention, a preferred embodiment the pulling mechanism of the portable moving apparatus employs a winch.

According to an additional aspect of the invention, a preferred embodiment of the portable moving apparatus for moving subjects includes a powered winch pulling mechanism.

According to yet another aspect of the invention, a preferred embodiment includes a portable power supply operably coupled to an electrically powered pulling mechanism.

According to another aspect of the invention, in a preferred embodiment, the portable moving apparatus for moving subjects also includes a portable power supply operably coupled to the pulling mechanism, as well as and a charging mechanism for charging the portable power supply.

According to an additional aspect of the invention, a preferred embodiment includes a ratchet mechanism associated with the pulling mechanism for selectably retarding lowering of the lifting line fitting.

According to another aspect of the invention, a preferred embodiment includes a ratchet mechanism associated with the pulley for selectably retarding lowering of the lifting line.

The invention has advantages including but not limited to providing one or more of the following features, improved mobility assistance, particularly in close quarters such as ingress and egress to a vehicle, improved safety, ease of operation, and convenience. These and other advantageous features and benefits of the invention can be understood by one of ordinary skill in the arts upon careful consideration of the detailed description of representative embodiments of the invention in connection with the accompanying drawings.

### BRIEF DESCRIPTION OF THE DRAWINGS

The invention will be more fully understood by reference to the detailed description, in conjunction with the following figures, wherein:

FIG. 1 is a top front perspective side view of an example of a preferred embodiment of apparatus for moving subjects according to the invention, depicting a lifting line and fitting, pulling mechanism, and a stem and support arm each employing pin-and-hole adjustable locking assemblies;

FIG. 2 is a top rear perspective side view of an example of an alternative preferred embodiment of apparatus for moving subjects according to the invention, showing a hand-powered winch, harness, and an adjustable support arm elevator assembly;

FIG. 3A is a top perspective partial side view of an example of a lifting line, fitting, harness, and pulleys in a preferred embodiment of apparatus for moving subjects according to the invention;

FIG. 3B is a top perspective partial side view of an example of a lifting line, fitting, harness, pulleys, and pulling mechanism in a preferred embodiment of apparatus for moving subjects according to the invention;

FIG. 4 is a top front perspective side view of an example of a preferred embodiment of apparatus for moving subjects according to the invention, showing an electrically powered pulling mechanism, hydraulically adjustable support arm elevator, and extendable support arm; and

FIG. 5 is a top rear perspective side view of an example of an alternative preferred embodiment of apparatus for moving subjects according to the invention, illustrating an implementation using a hydraulically adjustable telescoping support arm.

References in the detailed description correspond to like references in the various drawings unless otherwise noted. Descriptive and directional terms used in the written description such as right, left, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features, as well as novel aspects and advantages of the invention.

### DETAILED DESCRIPTION OF PREFERRED EMBODIMENTS

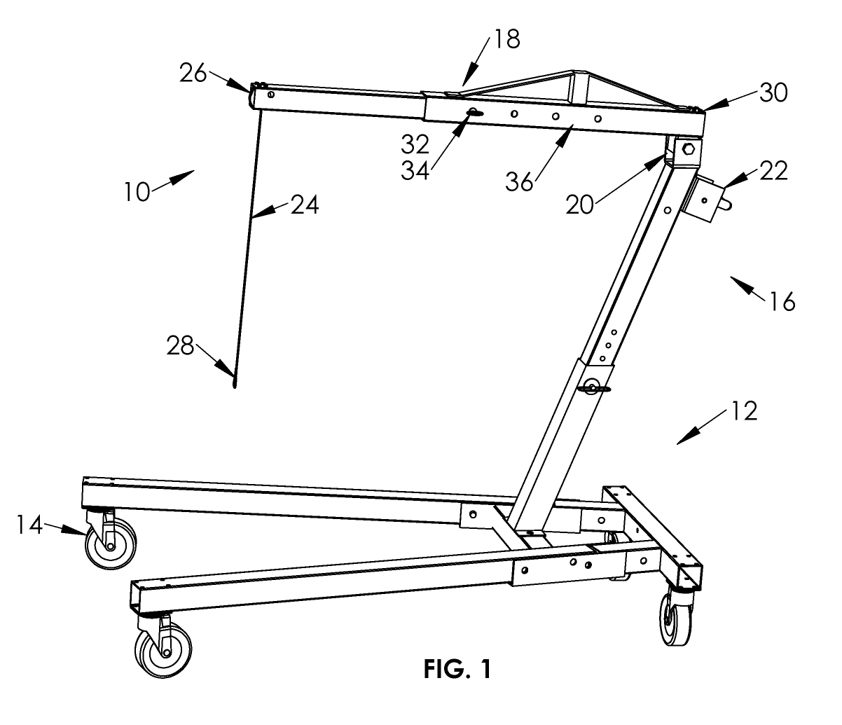

Initially referring primarily to FIG. 1, an exemplary embodiment of a portable moving apparatus 10 for moving subjects is shown. A base 12 provides a structural foundation for the apparatus 10. The base 12 is preferably configured to be low to the ground in order to avoid obstructing the subject to be moved, as well as to avoid obstructions to the horizontal movement of the apparatus 10. Preferably, the base 12 is adapted for positioning under many common wheel chairs, beds, or automobiles, for example. Preferably, one or more rolling devices 14 are attached to the base structure 12, in this case a number of wheels, so as to facilitate horizontal movement of the apparatus 10. A stem structure 16 extends upward from the base structure 12. A support arm 18 in turn extends substantially horizontally from the upper portion of the stem 16. The support arm 18 is secured with a joint 20 at the upper portion of the stem 16 such that the support arm 18 extends over the base 12. A pulling mechanism 22 is provided, in this case depicted mounted to the upper portion of the stem 16. A lifting line 24, preferably housed within the support arm 18 is operably connected to the pulling device 22. A pulley 26 is provided at the distal end of the support arm 18. The pulley 26 constrains the lifting line 24, and when the lifting line 24 is moved by the pulling mechanism 22, is operable to convert the substantially horizontal motion of lifting line along the support arm 18 to a lifting motion at the distal end of the lifting line 24. Preferably, the lifting line 24 is equipped with a fitting 28 attached at its distal end. Depending on the location of the pulling mechanism 22, one or more additional pulleys, e.g. 30, may be provided. In operation, a load, such as a human subject, or passenger, is secured to the distal end of the lifting line 24, preferably at the fitting 28, and is lifted by force applied at the pulling mechanism 22. Also illustrated in FIG. 1, in many applications it is preferable to provide the capability for the adjustment of the length of the support arm 18. In this example, a pin-and-hole arrangement 32, 34, is used, making the support arm 18 adjustable within a range of predetermined lengths by removing the pin 32, adjusting the length as shown by arrow 36, and inserting the pin 32 in a selected hole 34.

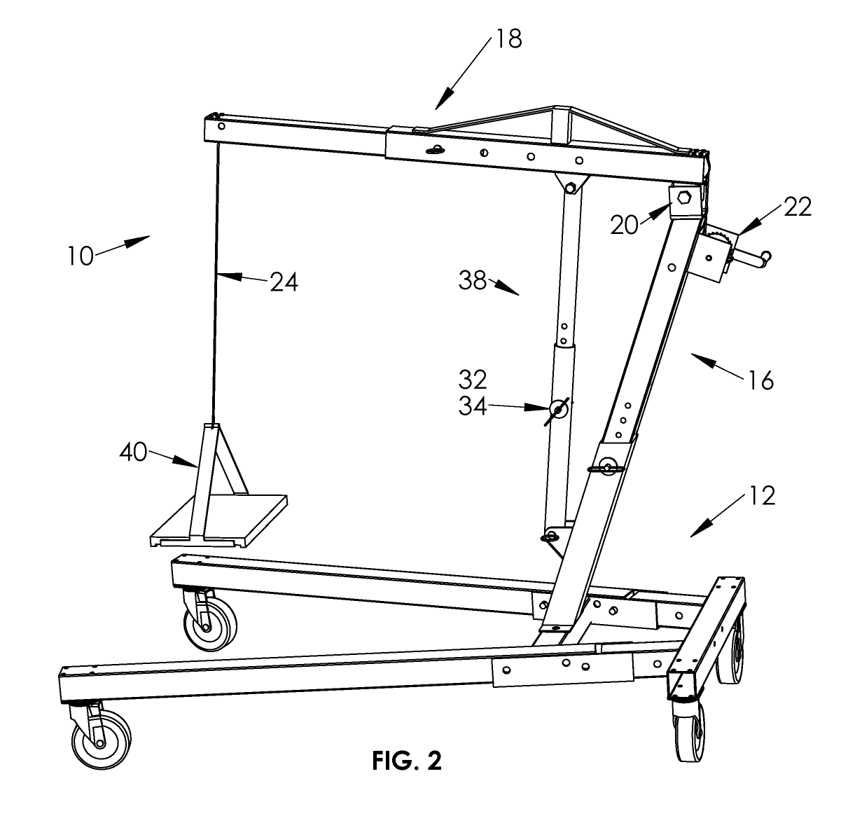

Now referring primarily to FIG. 2, an example of an alternative preferred embodiment of apparatus 10 for moving subjects is described. As can be seen in this example, the support arm 18 is preferably affixed to the stem 16 with a joint 20 suitable for pivoting, although a fixed joint may also be used. The use of a pivot joint 20 permits adjustment of the angle of the support arm 18 relative to the base 12, which may be advantageous for directing the movement of a load in some applications. A support arm elevator 38, attached between the support arm 18 and the stem 16, or between the support arm 18 and the base 12 (not shown), may be used to provide additional weight-bearing support to the support arm 18. The support arm elevator 38 is preferably adjustable in length, e.g., using pin 32 and hole 34 adjustments, in order to facilitate adjusting up or down for adapting the support arm 18 elevation relative to the horizontal. Also shown in FIG. 2, a harness 40 may preferably be used at the distal end of the lifting line 24 for securing a subject to be lifted and/or moved by the apparatus 10. As shown in FIG. 2, the pulling mechanism 22 may be a hand-cranked winch of suitable size and weight capacity.

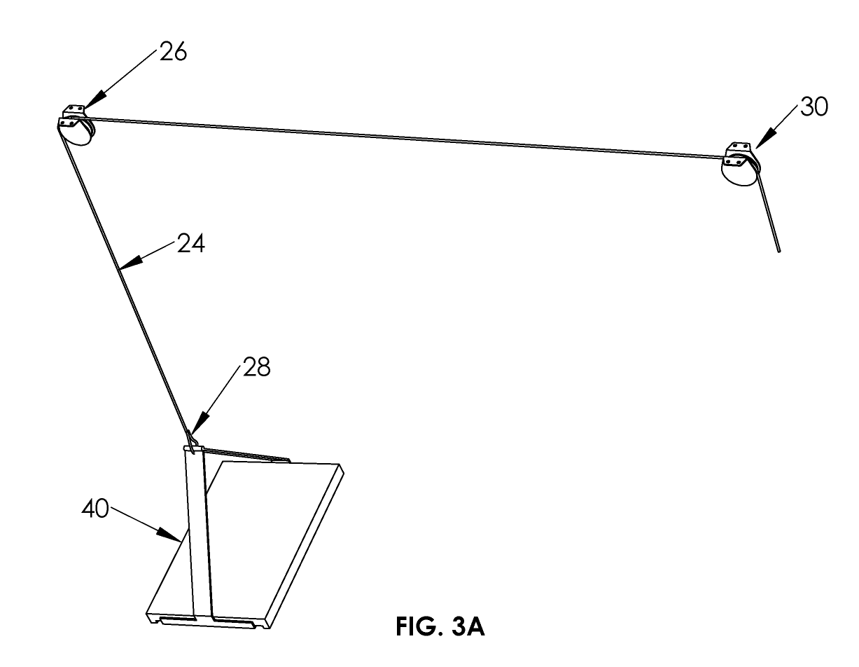

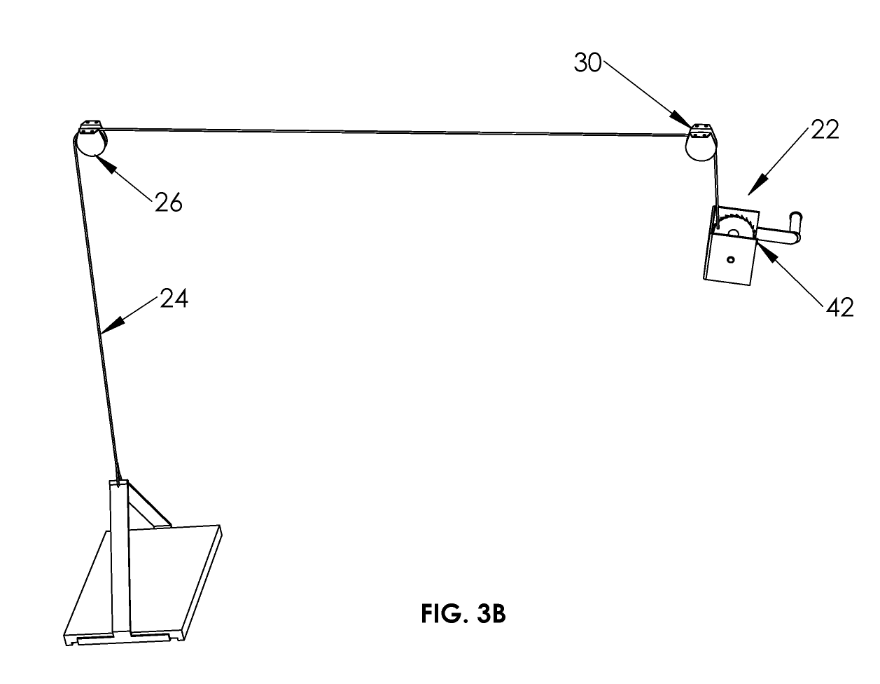

Further details of examples of preferred alternative embodiments of the lifting line 24 configuration and operation are shown in the top perspective partial side views of FIGS. 3A and 3B. FIG. 3A depicts a lifting line 24 constrained and supported by a pulley 26 near its distal end and by a second pulley 30 near the other end. At the distal end of the lifting line 24, a fitting 28, such as a hook, eye, shackle, or carabiner, for example, is preferably used to couple a harness 40 for securing a subject or passenger for lifting, moving, and lowering, by the action of the lifting line 24. The harness 40 may be configured according to the particulars of the subject and may include web strapping, seating, or other accommodations. As shown in FIG. 3B, the pulling mechanism 22 may be a winch, such as the hand-crank operated winch shown. Preferably, a ratchet and pawl mechanism 42 is provided to prevent uncontrolled or unintended lowering of a subject secured to the lifting line 24. The ratchet and pawl mechanism 42, shown here at the pulling mechanism 22, may also be located at one or more of the pulley locations, e.g. 26, 30. In addition to, or in place of a ratchet and pawl mechanism, other means for retarding the descent of, or for preventing sudden release of, the lifting line under load may be used.

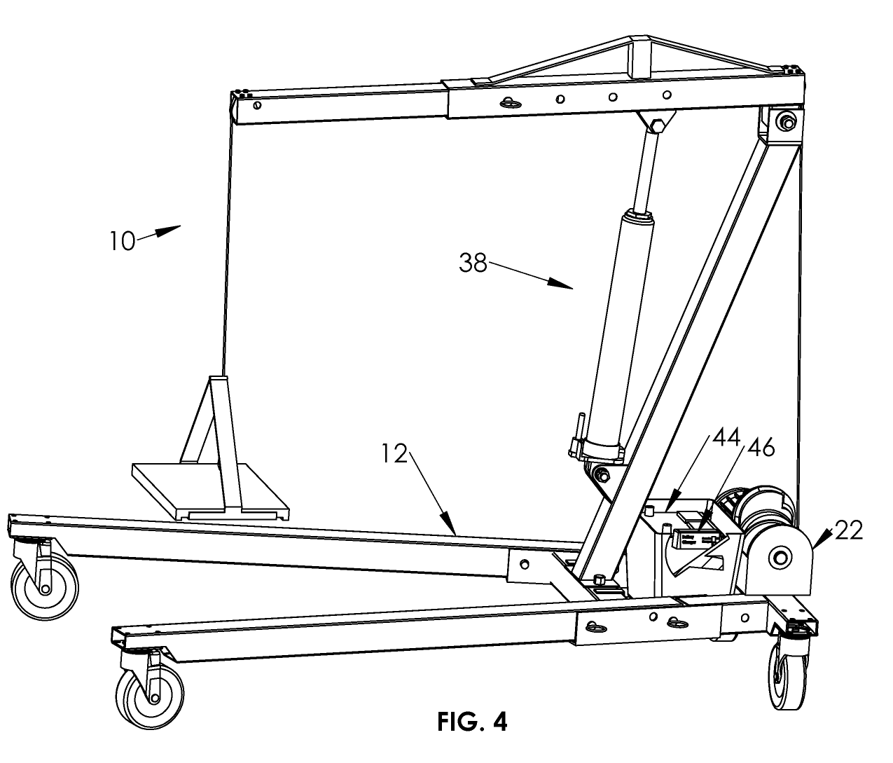

An additional embodiment of apparatus for moving subjects is shown in the top front perspective side view of FIG. 4. As can be seen in the figure, a powered pulling mechanism 22 such as an electric winch may be used, in this example shown mounted to the base 12. A suitable power and control module 44 is included. The power and support module may be adapted to the operating environment anticipated by the user of the apparatus 10. For example, a battery, with the optional inclusion of a charging system 46, may be used for portable applications, whereas a power cord for common household current may be used for more stationary or sheltered locations. An exemplary adjustable support arm elevator 38 is also shown. It should be appreciated by those skilled in the arts that the use of a hydraulic adjusting mechanism, for either the support arm, or support arm elevator 38 as shown, facilitates adjustment while subjected to a load. A pneumatic adjustment mechanism may also be used without departure from the principles of the invention. Another possible aspect of the invention is an engagement mechanism between the hoist and the support arm, inducing retraction of the support arm once the hoist has achieved a certain predetermined amount of lifting of the lifting line.

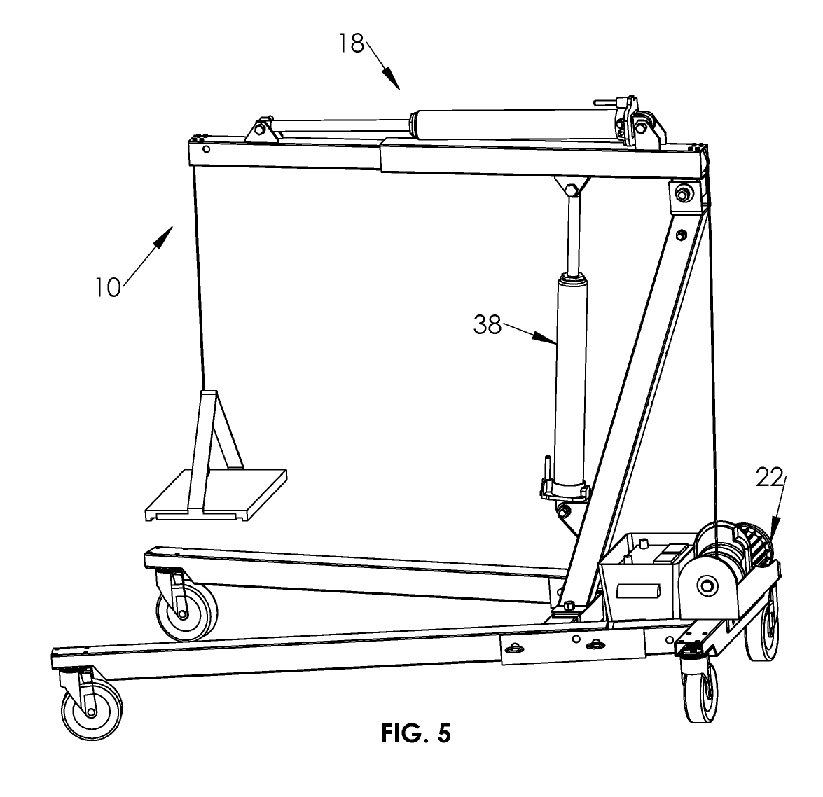

There are many possible variations and potential embodiments of the invention, which cannot, and need not, all be shown. Now referring primarily to FIG. 5, a top rear perspective side view of an example of an alternative preferred embodiment of apparatus for moving subjects according to the invention is shown. In this apparatus 10, a hydraulically adjustable telescoping support arm 18 is shown. Additionally, a hydraulic support arm elevator 38 is featured. An electrically powered winch is employed as a pulling mechanism 22. It should be understood that although the adjustment mechanisms shown and described herein may in some cases be operable to adjust the angle and height of the support arm under load, their primary function is to position the support arm according to the applicable operating environment. For example, it may be desirable to position the support arm for assisting a subject passenger in ingressing and egressing a particular vehicle. It is preferable that the pulling mechanism, and associated lifting line, perform the lifting and lowering functions required in use. Unlike the boom of a crane used for lifting, for example, the support arm is primarily used for positioning the lifting line, and lifting functions are secondary.

Other modifications and implementations will occur to those skilled in the art without departing from the spirit and the scope of the invention as claimed. For example, some variations in the physical configuration of the components are possible and may be advantageously employed in particular applications without departure from the invention, such as providing a pulling mechanism secured to the support arm, or coupling the support arm elevator assembly between the support arm and the base, or using casters instead of wheels. Accordingly, the above description is not intended to limit the invention except as indicated in the following claims.

What is claimed is:

1. A portable moving apparatus for moving subjects, comprising:
a base structure;
at least one rolling device attached to the base structure, so as to facilitate moving of the apparatus;
a stem structure rising from the base structure;
a moveable support arm having a proximal end attached to the stem structure, the support arm having pulley affixed to a distal end;
a moveable lifting line having a distal end fitting, the lifting line operably engaged by the pulley, the lifting line and fitting being capable of supporting a subject;
a pulling mechanism attached to the apparatus and operably coupled to the lifting line, whereby the fitting of the lifting line may be lifted towards the distal end of the support arm, thereby enabling a subject secured to the fitting to be lifted and moved.

2. The portable moving apparatus of claim 1, wherein the pulling mechanism is configured for lifting a subject without movement of the support arm.

3. The portable moving apparatus of claim 1, further comprising a pivot joint for pivotably coupling the support arm to the stem structure.

4. The portable moving apparatus of claim 1, further comprising a support arm elevator operably coupled to the support arm for pivoting and supporting the support arm relative to the stem structure.

5. The portable moving apparatus of claim 4, wherein the support arm elevator is operably connected to the support arm and the stem structure.

6. The portable moving apparatus of claim 4, wherein the support arm elevator is operably connected to the support arm and the base.

7. The portable moving apparatus of claim 4, wherein the support arm elevator includes a hydraulic mechanism operable for moving the support arm.

8. The portable moving apparatus of claim 4, wherein the support arm elevator includes a pneumatic mechanism operable for moving the support arm.

9. The portable moving apparatus of claim 1, wherein the support arm includes one or more telescopic sections for at least one of extending and retracting the distal end of the support.

10. The portable moving apparatus of claim 1, wherein the support arm further comprises one or more moveable peg-and-hole sections for at least one of extending and retracting the distal end of the support arm.

11. The portable moving apparatus of claim 1, wherein the fitting is a harness for securing a subject.

12. The portable moving apparatus of claim 1, wherein the lifting mechanism is secured to the base.

13. The portable moving apparatus of claim 1, wherein the lifting mechanism is secured to the stem.

14. The portable moving apparatus of claim 1, wherein the lifting mechanism is secured to the support arm.

15. The portable moving apparatus of claim 1, wherein the lifting mechanism further comprises a winch.

16. The portable moving apparatus of claim 1, wherein the lifting mechanism further comprises a powered winch.

17. The portable moving apparatus of claim 1 further comprising a portable power supply operably coupled to the lifting mechanism.

18. The portable moving apparatus of claim 17, further comprising a charging mechanism for charging the portable power supply.

19. The portable moving apparatus of claim 1 further comprising a ratchet mechanism associated with the lifting mechanism for selectably retarding lowering of the lifting line.

20. The portable moving apparatus of claim 1 further comprising a ratchet mechanism associated with the pulley for selectably retarding lowering of the lifting line.
